(19) United States
(12) Patent Application Publication
(10) Pub. No.: US 2003/0025455 A1
(43) Pub. Date: Feb. 6, 2003

(54) Ceramic HID lamp with special frame for stabilizing the arc

(76) Inventors: John C. Alderman, Corning, NY (US); Shiming Wu, Painted Post, NY (US)

Correspondence Address: Philips Electronics North America Corporation, 580 White Plains Road, Tarrytown, NY, 10591, US

(21) Appl. No.: 09/919,324

(22) Filed: Jul. 31, 2001

(51) Int. Cl. H01J 17/16; H01J 61/30

(52) U.S. Cl. 313/634; 313/635; 313/637

(57) ABSTRACT

The invention relates to a high-pressure discharge lamp of the ceramic metal halide type of the Philips MasterColor series having power ranges of about 150 W to about 1000 W. Such lamps are provided with outer bulb (10) enclosing a cylindrical ceramic discharge vessel (20) enclosing a discharge space, said cylindrical ceramic discharge vessel including within said discharge space an ionizable material comprising a metal halide; a first and second discharge electrode feedthrough means (30, 40); and a first and second current conductor (12, 13) connected to said first and second discharge electrode feedthrough means (30, 40), respectively. The lamp has a single substantially curved frame wire (17), connected to one of the current conductors (12, 13), extending between the ceramic discharge vessel and the glass bulb, and being separated from the discharge vessel by a distance effective to reduce at least one and preferably both arc bending and temperature of the frame when compared to a discharge lamp wherein the frame wire extends substantially parallel to the ceramic discharge vessel.

### FIELD OF THE INVENTION

The invention relates to a high-pressure discharge lamp which is provided with a discharge vessel that encloses a discharge space and includes a ceramic wall, the discharge space accommodating an electrode which is connected to an electric current conductor by means of a leadthrough element. The invention also relates to a high intensity discharge (HID) lamp having a discharge vessel light source, a glass stem, a pair of leads embedded in the glass stem, a glass envelope surrounding the light source, and a wire frame member with a first end fixed with respect to the stem, an axial portion extending parallel to the axis of the lamp, and a second end resiliently fitted in the closed end of the glass envelope.

### BACKGROUND OF THE INVENTION

High intensity (HID) lamps with translucent burners are well known in the art. The existing HID product range consists of mercury vapor (MV), high pressure sodium (HPS), and quartz metal halide (MH) lamps. In recent years, ceramic metal halide lamps (for example, Philips MasterColor® Series) have entered the market place. The MasterColor lamps are versatile light sources, since they can be mounted in either regular glass or quartz bulbs or in PAR reflectors. Existing Philips MasterColor ceramic metal halide lamps include such lamps having a wattage of 39 W-150 W, also referred to as CDM lamps). Recently, the MasterColor lamp series has been extended via work performed in our laboratory to higher wattages (up to 1000 W). These ceramic metal halide lamps display excellent initial color consistency, superb stability over life (lumen maintenance >80%, color temperature shift <200K at 10,000 hrs), high luminous efficacy of >90 lumens/watt and a lifetime of about 20,000 hours. These highly desirable characteristics are due to the high stability of the polycrystalline alumina (PCA) envelopes and a special mixture of salts, which emits a continuous-spectrum light radiation close to natural light and other parameters that have been identified and developed.

One current design of high wattage MasterColor lamps utilizes a cylindrical PCA discharge tube with extended plugs for securing electrodes. The approximate range of aspect ratio of the PCA discharge tube, i.e. length/diameter, of the PCA body is about 3 to 10, with the distance between two electrodes ranging from 10 mm to 60 mm. For the top of the line 400 W and 1000 W lamps, the lamp current is approximately 4.5 A (ANSI standard) in steady state operation and is approximately 7-8 A during warm up. The mount structure of the high wattage MasterColor lamps include a standard glass bulb with gas filling or vacuum, stem, connectors, getters, current carrying frame wire, and ignition aids such as UV enhancer or antenna. In the current design, the frame wire is straight and is mounted on the stem in parallel to the arc tube, and is similar to most HPS lamp constructions. The distance between the frame wire and arc tube surface is about 15 mm.

There are two consequences of this configuration: (1) the large current carried by the frame wire generates an AC magnetic field. The magnetic field interacts with the electrons and ions of the plasma stream. We have observed that the magnetic force is strong enough to push the plasma stream away from the axis of the PCA and results in arc bending. As a consequence of the arc bending, the PCA surface becomes extremely hot and adversely affects the life and other properties of the lamp. From working experience, we have found that the maximum working temperature of the PCA surface should not exceed 1250° C. The curving arc, which creates a much higher local surface temperature on the opposite side of the frame wire, results in PCA damage and even cracks; (2) The portion of the frame wire near the center of the arc tube is heated to well above 500° C. by the heat emitted from the arc tube. Under such a high temperature, the frame wire made with the most common stainless steel (eg. AISI 430) would slowly evaporate and deform to blacken the bulb and lose strength. In order to overcome the problem, a special high temperature alloy has to be used, which adds toward the cost of the lamp.

European Patent Application EP-342721, assigned to the same assignee as in this application, discloses an electric discharge lamp having a metallic frame for supporting a discharge vessel within an outer envelope, and has a frame portion along the discharge vessel. To suppress photo-emission of electrons the frame portion is coated with a granular oxide and the coated frame portion is bent outwardly to extend adjacent the outer envelope. This lamp is a quartz metal halide lamp with a relatively short, spherical arc tube, the dimensions of which tube are such that arc bending is not a problem, and indeed arc bending is not addressed. In addition, the surface temperatures of the quartz metal halide arc tube are significantly lower than the ceramic metal halide arc tube at same power. Therefore the heat impact on the frame wire is much smaller for the quartz metal halide lamps, so that the frame wire overheating is also not a problem, and indeed it is not addressed. This patent is directed European Patent Application EP-342721, assigned to the same assignee as in this application, discloses an electric discharge lamp having a metallic frame for supporting a discharge vessel within an outer envelope, and has a frame portion along the discharge vessel. To suppress photo-emission of electrons the frame portion is coated with a granular oxide and the coated frame portion is bent outwardly to extend adjacent the outer envelope. This lamp is a quartz metal halide lamp with a relatively short, spherical arc tube, the dimensions of which tube are such that arc bending is not a problem, and indeed arc bending is not addressed. This patent is directed to the problem of diminishing the effect of photoelectrons which accelerate the depletion of sodium within the discharge vessel and thus shortens the useful life of the lamp.

Great Britain Patent Specifications 1,149,022 and 1,215,480 relate to high pressure electric discharge metal halide lamps in which electrolytic migration of sodium through the quartz walls of an arc tube is reduced by a structure which includes a lead-in wire connected to a stiff lead-in wire through a thin conducting lead 20,48 which is as distantly removed from the arc tube as possible by bending it around the perimeter of the outer bulbous envelope. These structures employ what is conventionally referred to as field wires which do not support the arc tube and wherein the field wires are thin, i.e., they are typically effective to pass a current of about 3 amps but are insufficient to pass higher currents such as the 5-7 amps typically encountered with the high wattage ceramic metal halide lamps of the types under consideration herein. Here also, a relatively short, spherical arc tube is employed, the dimensions of which tube are such that arc bending is not a problem, and indeed arc bending is not addressed. These patents also are directed to the problem of diminishing the effect of photoelectrons which accelerate the depletion of sodium within the discharge vessel and thus shorten the useful life of the lamp. Attempts in our laboratory to prepare lamps according to the invention with such thin wires as disclosed in these patents were unsuccessful due to, among other failures, field wire melting at 5 amps. Increasing the diameter of the field wire could effectively reduce the temperature of the field wire and prevent it from melting. However, the flexibility of the field wire would be lost. Therefore the whole mount structure cannot be inserted into a standard size glass bulb through the narrow neck next to the base of the lamp.

There is a need in the art for HID lamps of the ceramic metal halide type with power ranges of about 150 W to about 1000 W, and for such lamps in which the arc bending problem is eliminated or at least minimized, and/or in which the frame wire temperature does not exceed the operation limit while using common stainless steel as the frame wire material.

### SUMMARY OF THE INVENTION

An object of the invention is to provide HID lamps of the ceramic metal halide type with power ranges of about 150 W to about 1000 W in which the arc bending problem is eliminated or at least minimized.

Another object of the invention is to provide HID lamps of the ceramic metal halide type with power ranges of about 150 W to about 1000 W in which the arc bending problem is eliminated or at least minimized, and in which the heat impact of the arc tube on the lamp components does not effectively reduce the lamp life.

The nominal voltage, as specified by applicable ANSI standards for HPS and MH varies from 100V to 135V for 150 W to 400 W lamps and then increases with the rated power to about 260V for 1000 W lamps. This is also the nominal voltage range for the lamps of this invention.

Another object of the invention is to provide ceramic metal halide lamps of the Philips MasterColor® series that display excellent initial color consistency, superb stability over life (lumen maintenance >80%, color temperature shift <200K at 10,000 hrs), high luminous efficacy of >90 lumens/watt, a lifetime of about 20,000 hours, and power ranges of about 150 W to about 1000 W, and in which the arc bending problem is eliminated or at least minimized, and in which the heat impact of the arc tube on the lamp components does not effectively reduce the lamp life.

Another object of the invention is to provide ceramic metal halide lamps having a power range of about 150 W to about 1000 W and exhibiting one or more of a characteristic selected from the group consisting of a CCT (correlated color temperature) of about 3800 to about 4500K, a CRI (color rendering index) of about 70 to about 95, a MPCD (mean perceptible color difference) of about ±10, a luminous efficacy up to about 85-95 lumens/watt, in which the arc bending problem is eliminated or at least minimized, and in which the heat impact of the arc tube on the lamp components does not effectively reduce the lamp life.

These and other objects of the invention are accomplished, according to a preferred embodiment of the invention in which the straight frame wire structure commonly used in HPS lamps is replaced with a curved frame wire and utilized in ceramic metal halide lamps. Preferably, a curved frame wire structure is used that extends adjacent to and substantially follows the contour of the glass bulb. Preferably also the distance between a center portion of the arc tube and a center portion of the curved frame wire is at least twice the distance between comparable portions of a conventional straight wire and arc tube. The increased distance at the center portion of the wire has been found to (1) reduce the magnetic field applied to the arc center to approximately the same level of the magnetic fields near the ends of the arc tube. This in turn prevents arc bending and consequent heating of the PCA surface near the bent arc, all leading to improved life of the lamp; and (2) to reduce the temperature of the frame wire by as much as 70° C., this in turn reducing the negative effects of heat radiation damage on the frame wire, such as evaporation of element Mn and deformation.

In preferred embodiments of the invention, the lamps will exhibit one or more of the common characteristics of higher wattage MasterColor® lamps: the aspect ratio of the arc tube body is higher than that of the lower wattage MasterColor lamps, eg. (30-150 W). The aspect ratio of the arc tube body of lower wattage lamps is about 1.0-1.5. For any given lamp power fothe lamps of the present invention, in the preferred embodiments, the aspect ratio (length/diameter) falls into a range of about 3.3-6.2, and/or the ceramic metal halide lamps of the Philips MasterColor® series display excellent initial color consistency; and/or superb stability over life (lumen maintenance >80%, color temperature shift <200K at 10,000 hrs); and/or high luminous efficacy of >90 lumens/watt; and/or a lifetime of about 20,000 hours; and/or power ranges of about 150 W to about 1000 W; and in each instance, will employ at least one curved frame wire which extends adjacent the glass bulb and is effective to at least minimize arc bending when the lamp is operated; and/or lamps are provided having a power range of about 150 W to about 1000 W and exhibiting one or more of a characteristic selected from the group consisting of a CCT (correlated color temperature) of about 3800 to about 4500K, a CRI (color rendering index) of about 70 to about 95, a MPCD (mean perceptible color difference) of about ±10, a luminous efficacy up to about 85-95 lumens/watt, in which the arc bending problem is eliminated or at least minimized.

### BRIEF DESCRIPTION OF THE DRAWING

The above aspects and further aspects of the lamps in accordance with the invention will be described in detail hereinafter with reference to the drawing in which:

FIG. 1 is a schematic of a lamp according to a preferred embodiment of the invention; and

FIG. 2 is a schematic of a lamp according to another preferred embodiment of the invention

The invention will be better understood with reference to the details of specific embodiments that follow:

### DETAILED DESCRIPTION OF THE PREFERRED EMBODIMENTS

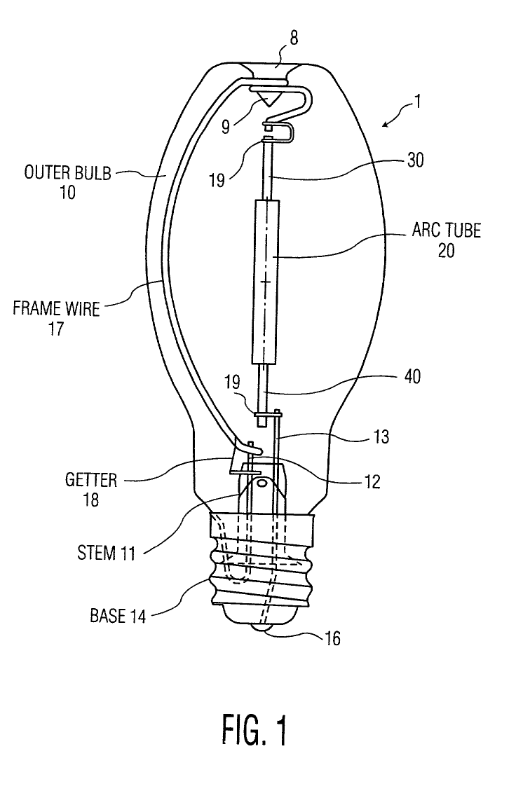

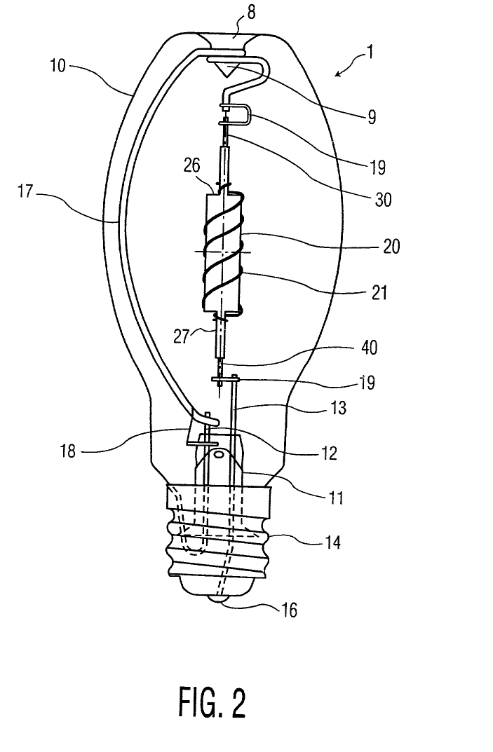

Referring to FIGS. 1 and 2, a ceramic metal halide discharge lamp 1 comprises a glass outer envelope 10, a glass stem 11 having a pair of conductive stem leads 12, 13 embedded therein, a metal base 14, and a center contact 16 which is insulated from the base 14. The stem leads 12, 13 are connected to the base 14 and center contact 16, respectively, and not only support an arc tube 20, but also supply current to the electrodes 30, 40 via frame wire member 17 and stem lead member 13. Optionally, a getter 18 is fixed to the frame wire member 17. Connectors 19, preferably niobium connectors, provide an electrical connection for the arc tube electrode feedthroughs 30 and 40. Beyond this the frame member 17 is provided with an end portion 9 that contacts a dimple 8 formed in the upper axial end of the glass envelope 10. In this embodiment of the invention, the aspect ratio is within the range of about 3-10.

In this embodiment of the invention, by using a curved frame wire 17 that substantially follows the shape of the glass bulb 10, the distance between the center portion of the wire 17 and the center portion of the arc tube 20 is increased to the extent that detrimental interaction between the frame wire and the arc is greatly reduced and in some cases eliminated. For example, no arc bending was observed at up to 714 W of power and 8.13 amps of AC current. Additionally, in horizontal burning condition with the field wire located above the burner, the arc was kept straight, i.e., no arc bending was observed.

In this embodiment of the invention, by using a curved frame wire 17 that substantially follows the shape of the glass bulb 10, the distance between the center portion of the wire 17 and the center portion of the arc tube 20 is increased to the extent that the maximum temperature of the frame wire is greatly reduced to the extent that a most common stainless steel material can be employed without affecting lamp life. For example, at 400 W, 450 W and 500 W, the maximum temperatures of a straight frame wire were 513° C., 533° C. and 553° C., respectively, while using the curved frame the same temperatures were 441° C., 470° C. and 494° C., respectively.

The arc tube 20 is formed as a ceramic tube preferably having disc-like end walls with central apertures which receive end plugs. Preferably, the end plugs are also formed as ceramic tubes, and receive electrodes 30, 40 therethrough. The electrodes 30, 40 each have a lead-in, preferably of niobium which is sealed with a frit which hermetically seals the electrode assembly into the PCA arc tube. The barrel and end walls enclose a discharge space containing an ionizable filling of an inert gas, a metal halide, and mercury.

As used herein, “ceramic” means a refractory material such as a monocrystalline metal oxide (e.g. sapphire), polycrystalline metal oxide (e.g. polycrystalline densely sintered aluminum oxide and yttrium oxide), and polycrystalline non-oxide material (e.g. aluminum nitride). Such materials allow for wall temperatures of 1500-1600K and resist chemical attacks by halides and Na. For purposes of the present invention, polycrystalline aluminum oxide (PCA) has been found to be most suitable.

Optionally, as illustrated in the embodiment of FIG. 2, the ceramic metal halide arc tube may have a conductive antenna coil 21 wrapped around the arc tube 20 and around the extended plugs 26, 27 to reduce the breakdown voltage at which the fill gas ionizes by a capacitive coupling between the coil and the adjacent lead-in in the plug. The coil is insulated from the frame wire and also serves as a containment in the event of rupture of the arc tube. When an AC voltage is applied across the electrodes, the antenna stimulates UV emission in the PCA, which in turn causes primary electrons to be emitted by the electrode. The presence of these primary electrons hastens ignition of a discharge in the fill gas.

Thus to summarize, there is provided high wattage discharge lamps which comprise a ceramic discharge vessel which encloses a discharge space and is provided with preferably a cylindrical-shaped ceramic, preferably a sintered translucent polycrystalline alumina, arc tube with electrodes, preferably tungsten-molybdenum-cermet-niobium electrodes or tungsten-cermet-niobium electrodes, attached on either side by gas-tight seals. Metallic mercury, a mixture of noble gases and, optionally, radioactive ⁸⁵Kr, and a salt mixture such as a mixture composed of sodium iodide, calcium iodide, thallium iodide and several rare earth iodides are contained in the arc tube. The arc tube is preferably protected from explosion by a molybdenum coil, which also serves as antenna for starting. The entire arc tube and its supporting structure are enclosed in a standard-size lead-free hard glass bulb, and further comprises a frame wire which is curved and extends outwardly from the arc tube and, preferably, substantially follows the contours of the glass bulb, i.e. it extends away from the arc tube and thereby mitigates or substantially reduces or eliminates arc bending in the lamp.

It will be understood that the invention may be embodied in other specific forms without departing from the spirit and scope or essential characteristics thereof, the present disclosed examples being only preferred embodiments thereof.

We claim:

1. A discharge lamp (1) comprising an outer bulb (10) enclosing a ceramic discharge vessel (20) enclosing a discharge space, said cylindrical ceramic discharge vessel including within said discharge space an ionizable material comprising a metal halide; a first and second discharge electrode feedthrough means (30, 40); and a first and second current conductor (12, 13) connected to said first and second discharge electrode feedthrough means (30, 40), respectively;
said lamp having a single substantially curved frame wire (17), connected one of said current conductors (12, 13), extending between said ceramic discharge vessel and said glass bulb, and being separated from the discharge vessel by a distance effective to reduce arc bending when compared to a discharge lamp wherein said frame wire extends substantially parallel to the ceramic discharge vessel.

2. A lamp as claimed in claim 1, wherein the ceramic discharge vessel is a substantially cylindrical arc tube.

3. A lamp as claimed in claim 2, wherein said frame wire (17) extends outwardly from said arc tube (20) at a distance whereby the maximum distance between the arc and the curved frame wire (17) is at least twice the distance when compared to a discharge lamp wherein said frame wire extends substantially parallel to the arc tube.

4. A lamp as claimed in claim 2, having a power range of about 150 W to about 1000 W and exhibiting one or more of a characteristic selected from the group consisting of a CCT (correlated color temperature) of about 3800 to about 4500K, a CRI (color rendering index) of about 70 to about 95, a MPCD (mean perceptible color difference) of about ±10, and a luminous efficacy up to about 85-95 lumens/watt and/or in which the heat impact of the arc tube on the lamp components does not effectively reduce the lamp life.

5. A lamp as claimed in claim 2, wherein said frame wire (17) is a curved frame wire that extends adjacent to and substantially follows the contour of the glass bulb (10) and in which the heat impact of the arc tube on the lamp components does not effectively reduce the lamp life.

6. A lamp as claimed in claim 1 retrofit with ballasts designed for high pressure sodium or quartz metal halide lamps.

7. A lamp as claimed in claim 2, wherein the approximate range of the aspect ratio of the arc tube (20) is about 3 to 10, with the distance between two electrodes (30, 40) ranging from 10 mm to 60 mm.

8. A lamp as claimed in claim 7, wherein the aspect ratio of said arc tube falls within the range of about 3.3-6.2.
